(19) United States
(12) Patent Application Publication
(10) Pub. No.: US 2014/0116303 A1
(43) Pub. Date: May 1, 2014

(54) RAPID DEPLOYMENT GUN SAFE

(71) Applicant: Charles L. Mothersele, Fishers, IN (US)

(72) Inventor: Charles L. Mothersele, Fishers, IN (US)

(21) Appl. No.: 14/055,441

(22) Filed: Oct. 16, 2013

Related U.S. Application Data
(60) Provisional application No. 61/719,646, filed on Oct. 29, 2012.

(51) Int. Cl. E05G 1/026

(52) U.S. Cl. CPC E05G 1/026
USPC 109/64

(57) ABSTRACT

Certain disclosed embodiments provide for a gun safe including a housing having an interior cavity. A lid is hingedly attached to the housing. The lid is moveable between an open position and a closed position. In the closed position, the lid closes the interior cavity. An electronic latch is operable to retain the lid in the closed position and release the lid to the open position when the electronic latch is operated. A holster is positioned on the interior surface of the lid. The holster is configured to retain a gun so that the gun is housed in the interior cavity when the lid is in the closed position.

### CROSS-REFERENCE TO RELATED APPLICATIONS

This application is a non-provisional application of, and claims priority to, U.S. Patent Application Ser. No. 61/719646 filed Oct. 29, 2012 and titled “RAPID DEPLOYMENT GUN SAFE”, which is herein incorporated by reference in its entirety.

### TECHNICAL FIELD OF THE DISCLOSURE

The present disclosure generally relates to safes and, more particularly, to a rapid deployment gun safe.

### BACKGROUND OF THE DISCLOSURE

It is known in the art to provide gun safes to protect firearms from unauthorized use and from being stolen. Gun safes are typically constructed from steel and provided with a locking latch. There have additionally been provided gun safes for motor vehicles, particularly with respect to firearms used by law enforcement personnel. While the prior art gun safes provide secure storage for the firearm(s) contained therein, most designs suffer from not allowing the firearms to be accessed quickly when needed. Additionally, prior art gun safes designed for motor vehicles suffer from restrictions on the manner in which they may be mounted in the motor vehicle and still be usable.

Therefore, there is a need for improved designs for gun safes. The present disclosure is directed toward meeting this need.

### SUMMARY OF THE DISCLOSURE

Certain disclosed, embodiments provide for a gun safe that is designed to hold a pistol and provide quick access to same. Because of the design of the gun safes disclosed herein, they may be mounted in a variety of orientations, while still allowing for quick access to the gun located within the safe. The gun safes disclosed herein are particularly useful for mounting within motor vehicles.

In one embodiment, a gun safe includes a housing having an interior cavity. A lid is hingedly attached to the housing. The lid is moveable between an open position and a closed position. In the closed position, the lid closes the interior cavity. An electronic latch is operable to retain the lid in the closed position and release the lid to the open position when the electronic latch is operated. A holster is positioned on the interior surface of the lid. The holster is configured to retain a gun so that the gun is housed in the interior cavity when the lid is in the closed position.

In one embodiment, a gun safe includes a housing having an interior cavity. A lid is attached to the housing. A gas cylinder couples the lid to the housing. The lid is moveable between an open position and a closed position. When the lid is moved to the closed position, gas within the gas cylinder is compressed. A latch is operable to retain the lid in the closed position. When the latch is operated, the gas in the gas cylinder expands to move the lid into the open position. A holster is positioned on the interior surface of the lid. The holster is configured to retain a gun so that the gun is housed in the interior cavity when the lid is in the closed position.

In one embodiment, a gun safe includes a housing having an interior cavity. A lid is attached to the housing. The lid is moveable between an open position and a closed position. A gas cylinder couples the lid to the housing and is configured to move the lid into the open position. An electronic latch is operable to retain the lid in the closed position and release the lid to the open position when the electronic latch is operated. A holster is positioned on the interior surface of the lid. The holster is configured to retain a gun so that the gun is housed in the interior cavity when the lid is in the closed position. A protective material lines the interior surface of the lid to protect the gun. The protective material has a cut out section to provide a gap between the interior surface of the lid and a handle of the gun.

Other embodiments are also disclosed.

### BRIEF DESCRIPTION OF THE DRAWINGS

FIG. 1 is a front view of a gun case formed in accordance with an embodiment and in the open position.

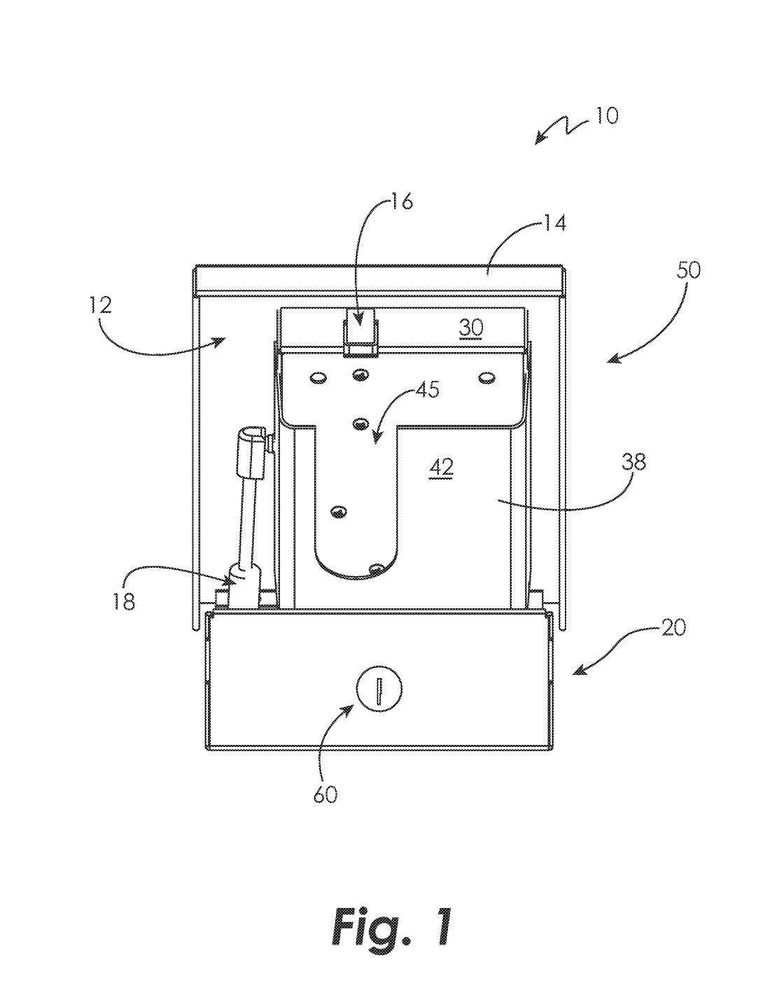

FIG. 2 is a side view of the gun case shown in FIG. 1.

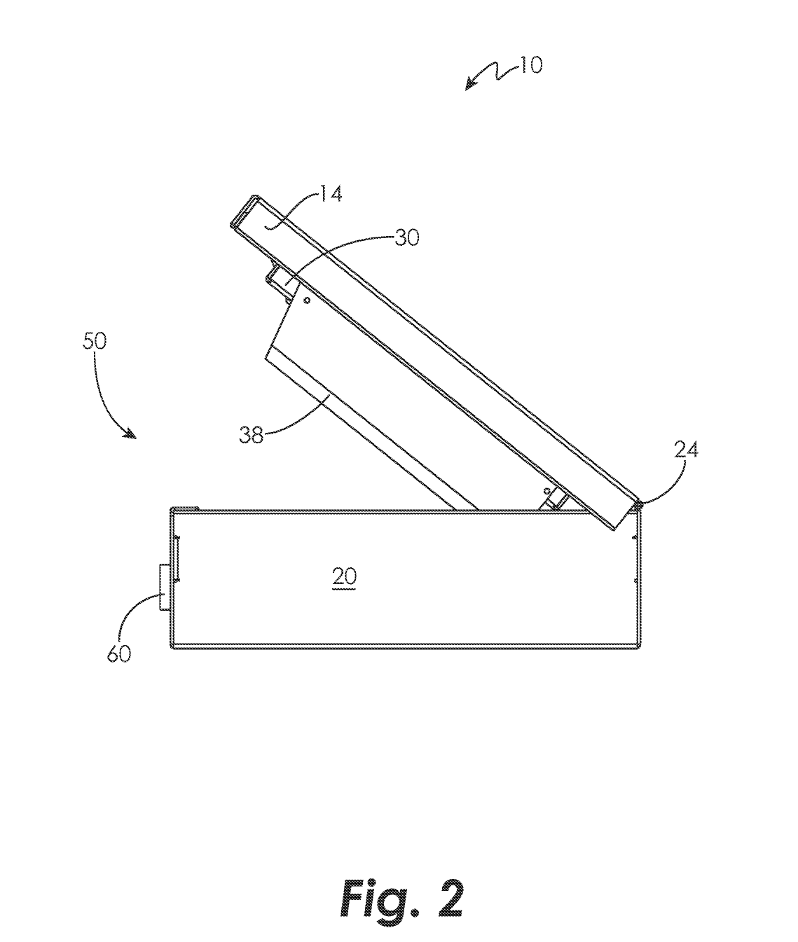

FIG. 3 is an opposite side view of the gun case shown in FIG. 1.

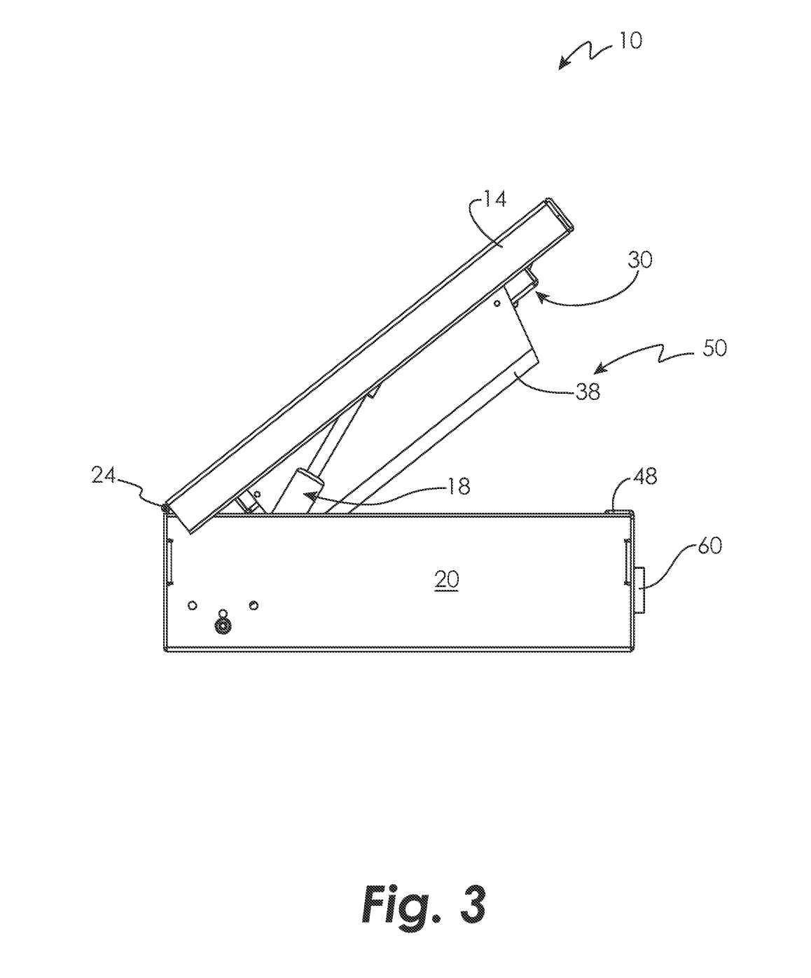

FIG. 4 is a top view of the gun case shown in FIG. 1.

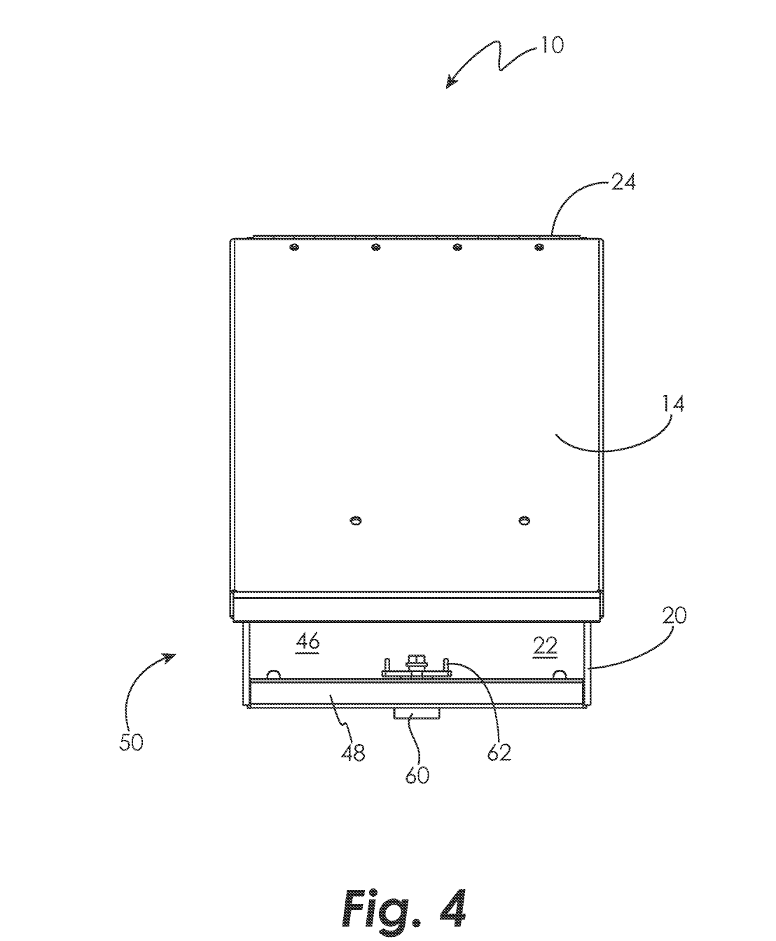

FIG. 5 is a top perspective view f the gun ease shown in FIG. 1.

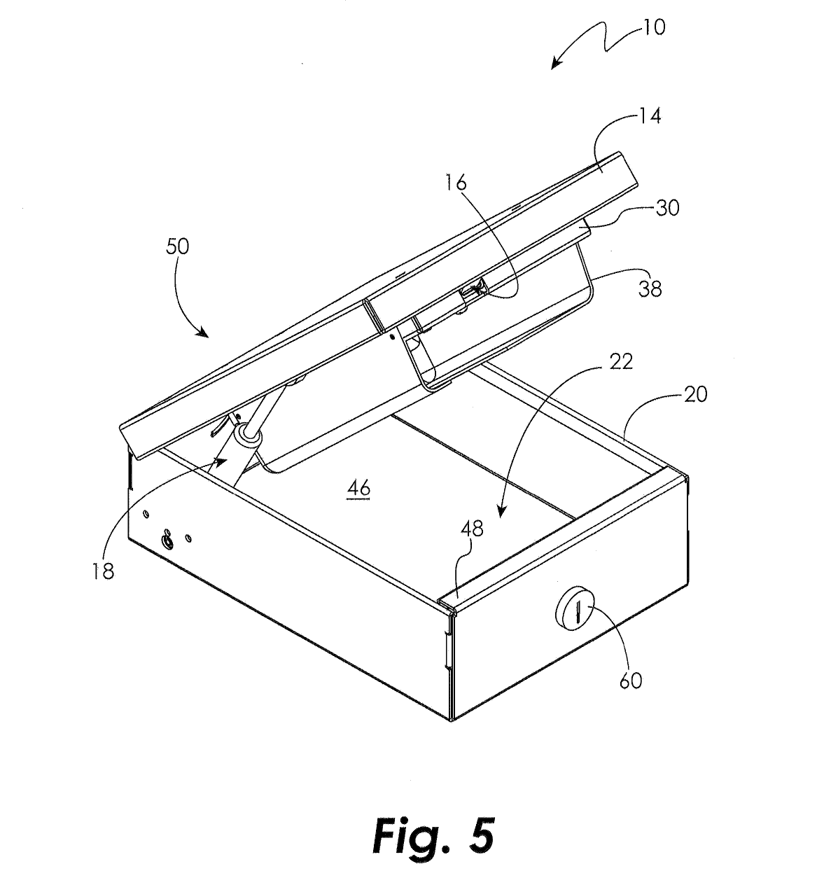

FIG. 6 is a bottom perspective view of the gun case shown in FIG. 1.

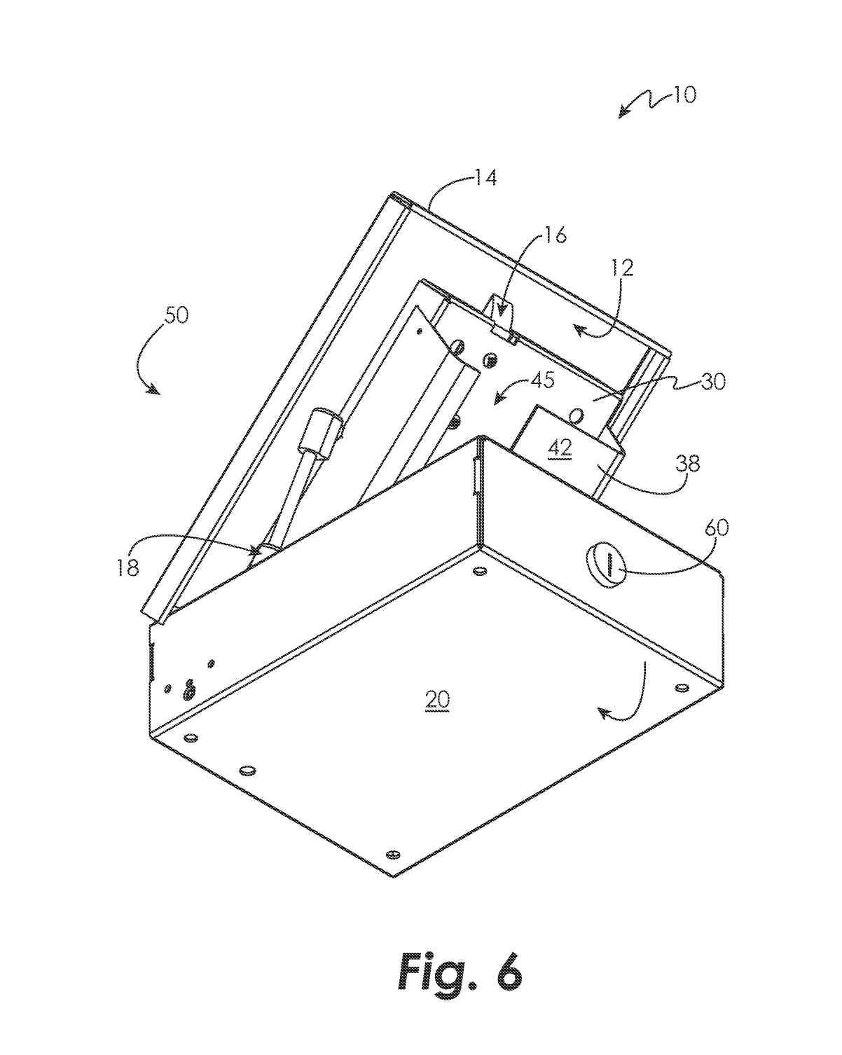

FIG. 7 is an exploded view of the gun case shown in FIG. 1.

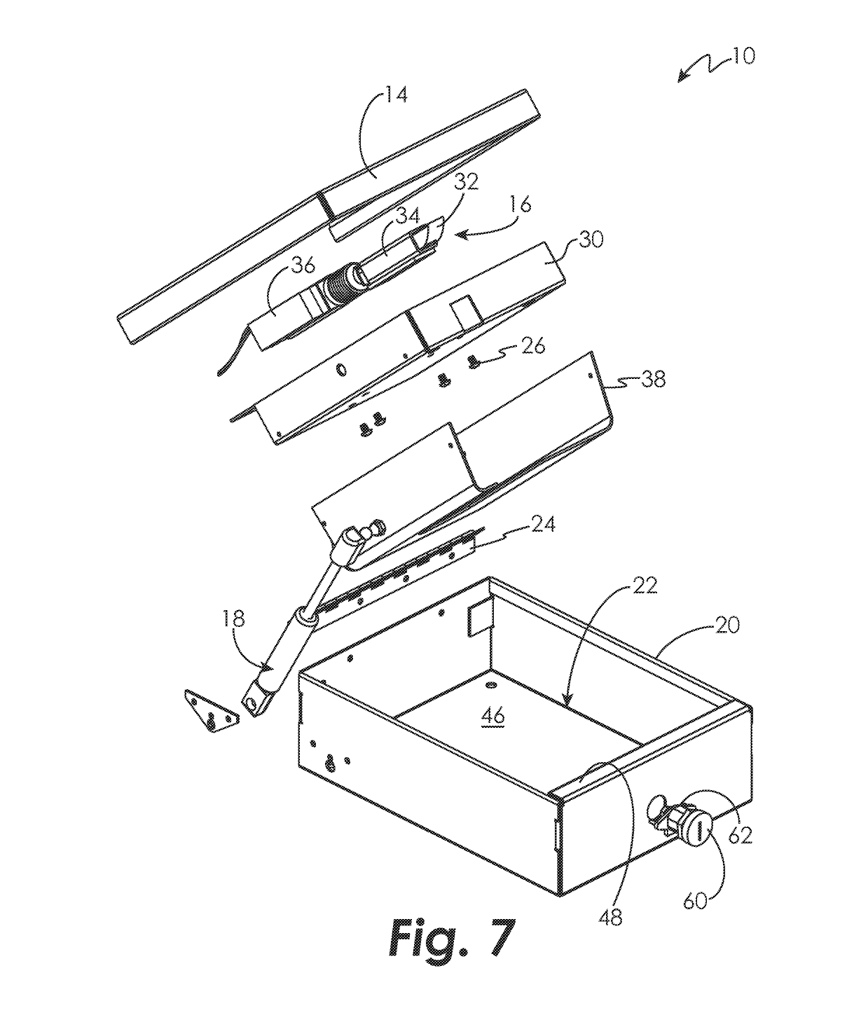

FIG. 8 is a top perspective view of the gun case shown in FIG. 1 and in the closed position.

FIG. 9 is a top perspective view of the gun case shown in FIG. 1 and having a gun positioned therein.

FIG. 10 is an exploded view of the gun case shown in FIG. 1 and the gun shown in FIG. 9.

FIG. 11 is a top perspective view of the gun case shown in FIG. 1 having gun and a protective material positioned therein.

FIG. 12 is an exploded view of the gun case shown in FIG. 1 and the gun and protective material show in FIG. 11.

### DETAILED DESCRIPTION OF THE DISCLOSED EMBODIMENTS

For the purposes of promoting an understanding of the principles of the disclosure, reference will now be made to the embodiments illustrated in the drawings and specific language will be used to describe the same. It will nevertheless he understood that no limitation of the scope of the disclosure is thereby intended, and alterations and modifications in the illustrated systems, and further applications of the principles of the disclosure as illustrated therein are herein contemplated as would normally occur to one skilled in the art to which the disclosure relates.

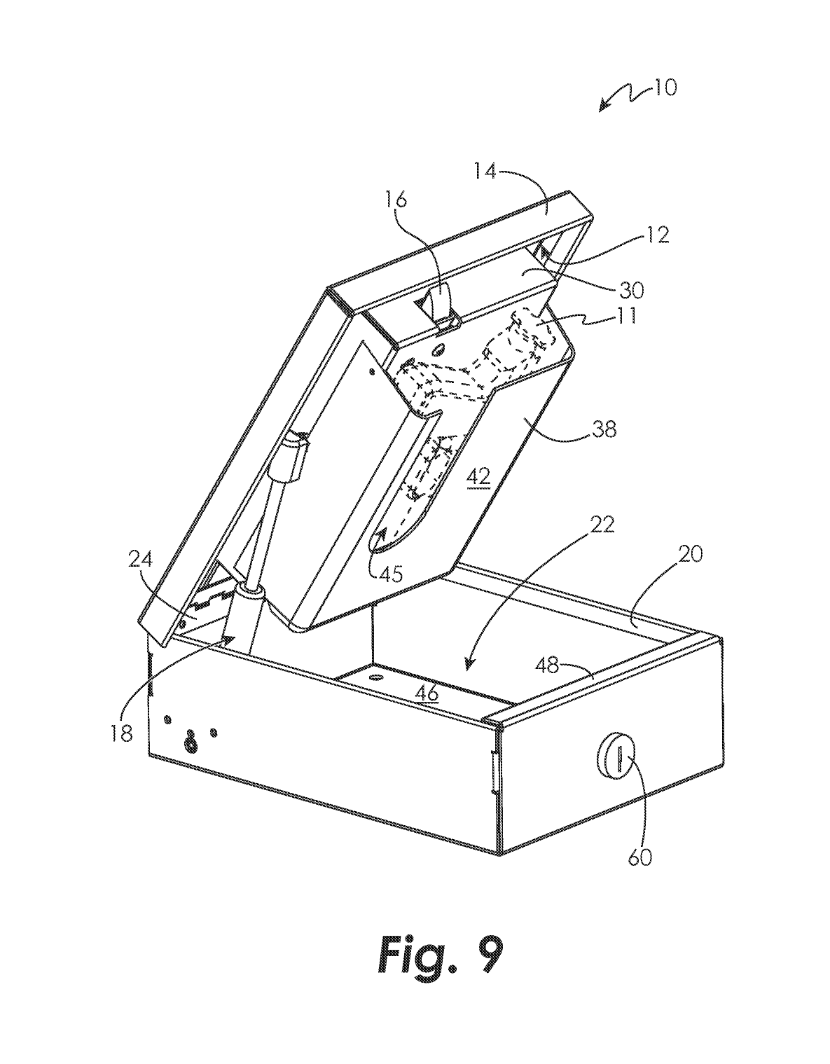

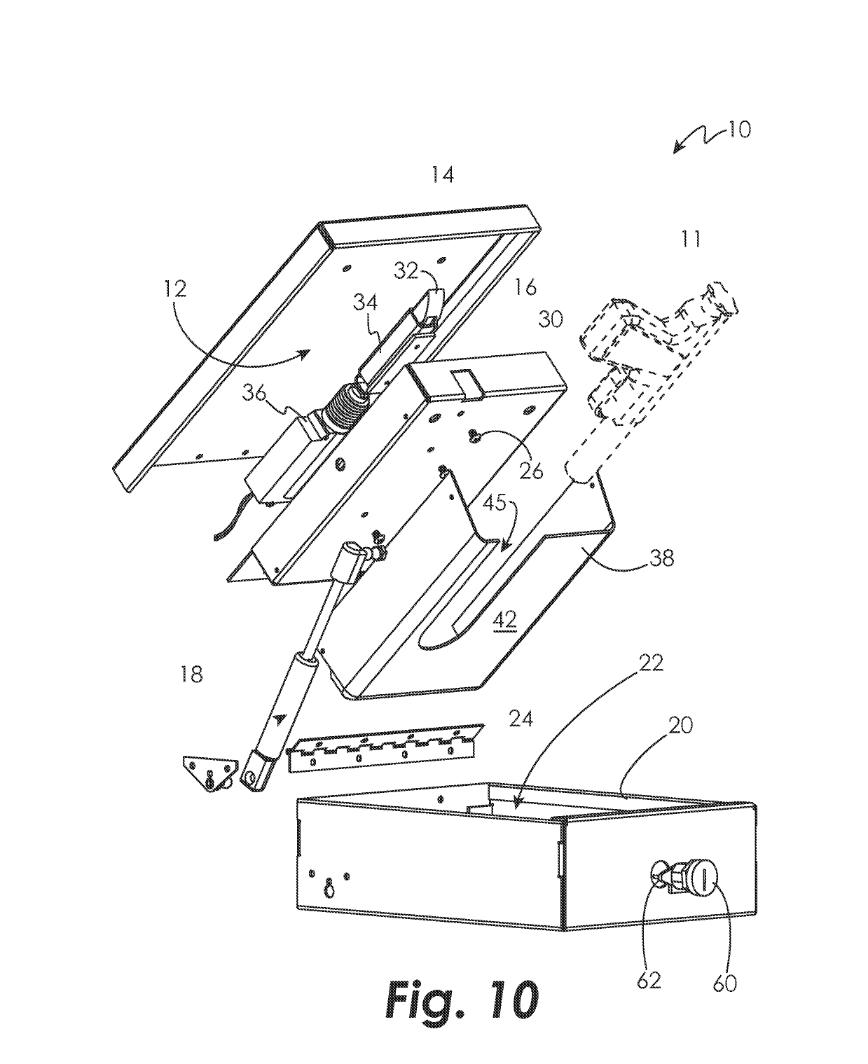

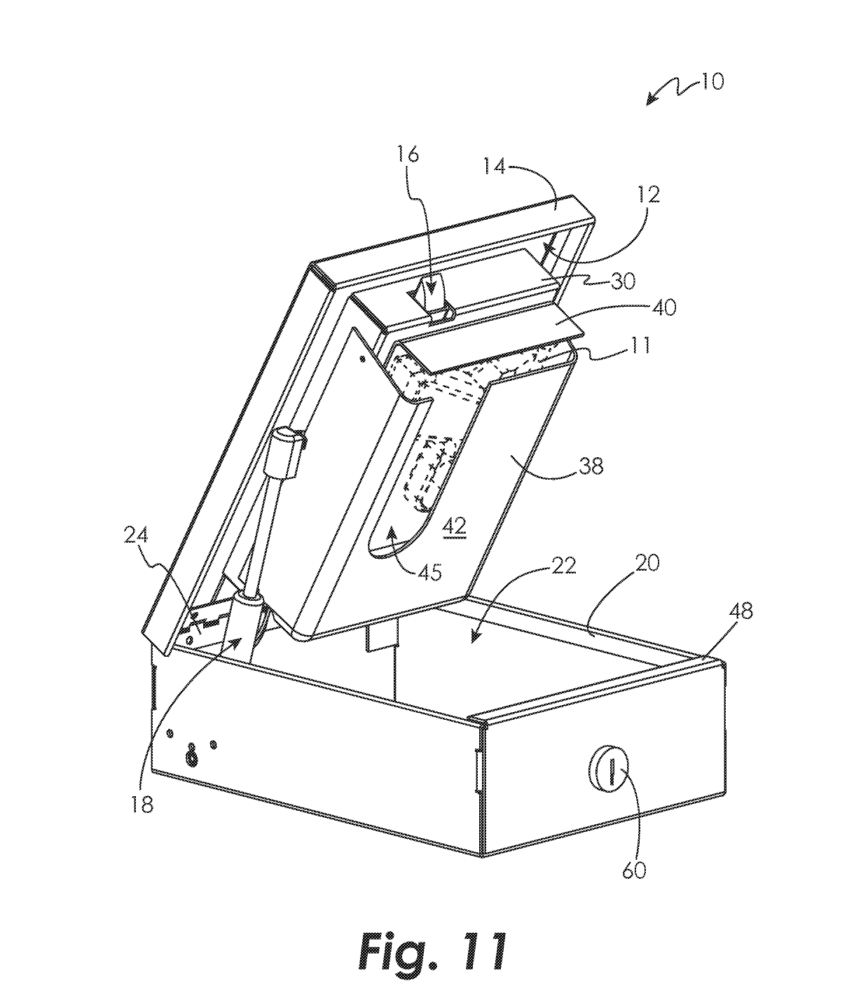

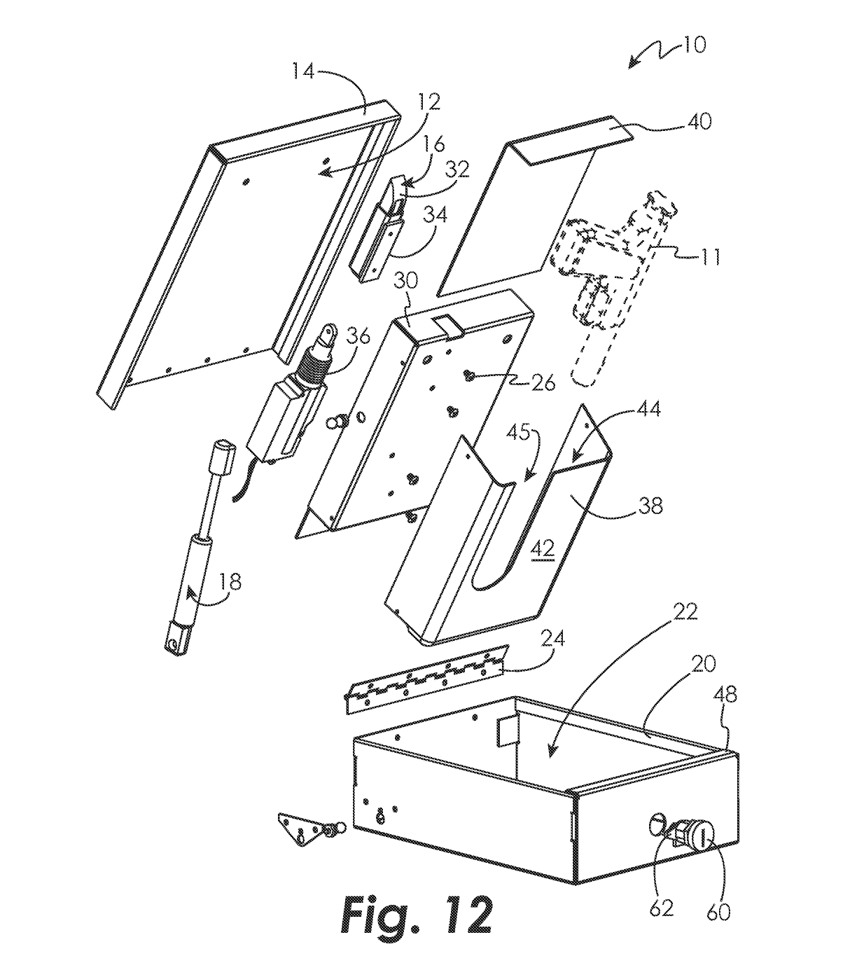

In certain embodiments, the present disclosure is directed to a gun safe 10 that carries a pistol 11 (shown in FIGS. 9-12) attached to the inside surface 12 of a hinged lid 14. The gun safe 10 includes a latching device 16 that may be remotely actuated, whereupon the lid 14 is automatically moved to an open position by means of a gas cylinder 18. In the open position, the pistol 11 is easily reached and removed by the user.

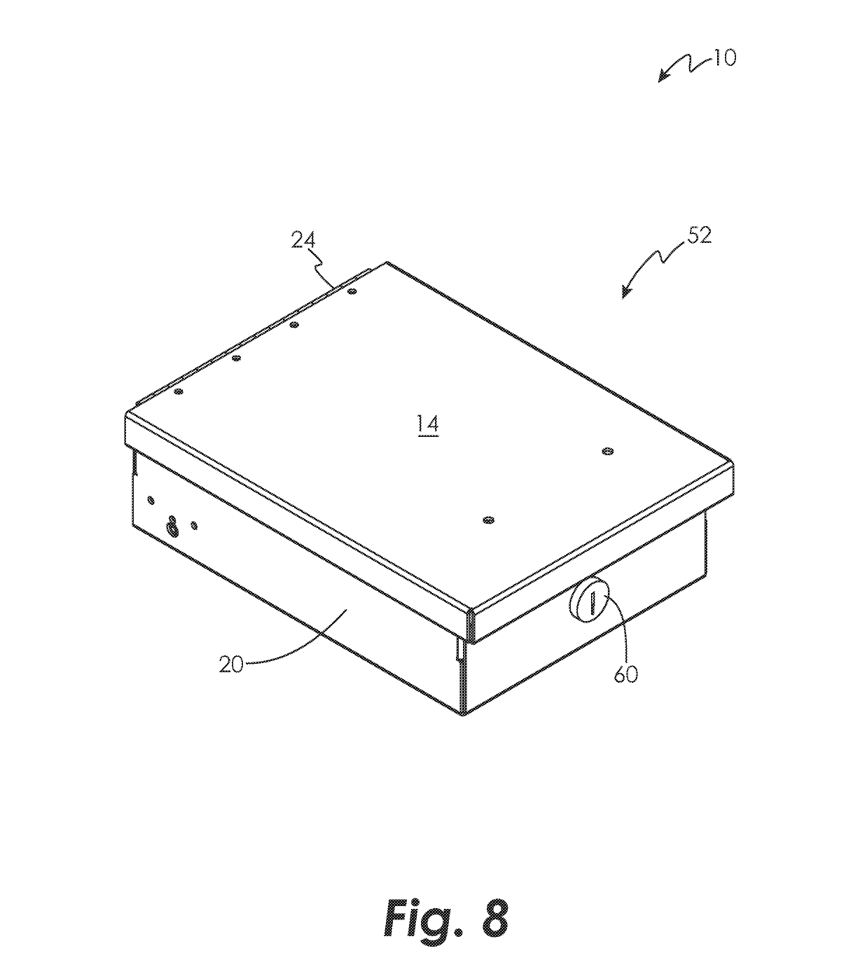

One embodiment of the gun safe 10 will now be illustrated and described. The safe 10 includes a housing 20 forming an enclosure 22 or interior cavity. The enclosure 22 includes a hinge 24 mounted thereto. The hinge 24 allows mounting of a lid 14. The lid 14 includes bolts 26 for coupling the lid 14 to the hinge 24, as well as two mounting posts for securing a latching device cover 30. In one embodiment, the latching device 16 comprises a sliding latch 32 coupled to an electronic linear actuator 34 mounted to the underside of the latching device cover 30. The lid 14 is moveable between an open position 50 and a closed position 52 (as shown in FIG. 8), wherein, in the closed position 52, the lid 14 closes the interior cavity 22 of the safe 10. The latching device 16 is operable to retain the lid 14 in the closed position 52 and release the lid 14 to the open position 50 when the latching device 16 is operated.

The linear actuator 34 (or other drive mechanism for the sliding latch 32) is provided power by means of wires, for example, in motor vehicle applications, the linear actuator 34 is powered by the motor vehicle's electrical system through a momentary switch 36 that may be used to the actuate gun safe 10 when it is desired to open the gun safe 10. The momentary switch 36 only sends power to the linear actuator 34 when the switch is activated. A positive line of the momentary switch 36 sends power to the linear actuator 34 to power a motor, for example a direct current motor, that operates at least one gear to linearly move the linear actuator 34. In some embodiments, the switch 36 may be remotely actuated by a suitable wireless receiver as will be appreciated by those skilled in the art.

The latching device cover 30 is mounted to the inside surface 12 of the gun safe 10 lid 14. A lip on the enclosure 22 engages the sliding latch 32 when the gun safe 10 is locked. The gun safe 10 also provides a key that is inserted into a key override 60. Turning the key will move an override arm 62, which in turn will engage the sliding latch 32 and move it away from the lip on the enclosure 22, allowing the lid 14 to open. The key override 60 provides access to the gun safe 10 in the event of loss of power, loss of a remote actuator for the wireless receiver, or in case of malfunctioning of any part of the latching system 16.

The latching device cover 30 also provides the surface to which a gun holster 38 is mounted. A piece of protective material 40, such as carpeting, may be mounted to the latching device cover 30 in order to protect the pistol 11 from damage as it is slid in and out of the holster 38. An outer portion 42 of the holster 38 creates a cavity 44 for holding the pistol 11 when the outer portion 42 is mounted to the latching device cover 30. In some embodiments, the outer portion 42 of the holster 38 includes a cut-away section 45 to facilitate gripping the pistol 11 when inserting or removing the pistol 11 from the gun safe 10. In some embodiments, the cut-away portion 45 is formed opposite that illustrated to facilitate use by left handed users. Some embodiments include protective material 40 that is long enough to fold over the end of the gun 11 when it is holstered, whereby the end of the protective material 40 may mate with hook material (one half of a hook and loop closure) mounted to the holster outer portion 42 in order to securely contain the pistol 11 within the holster 38. The holster 38 and the protective material 40 may be mounted to the latching device cover 30.

The gas cylinder 18 is mounted between the enclosure bottom 46 and the latching device cover 30. When the lid 14 is closed, this action compresses the gas within the gas cylinder 18, such that when the sliding latch 32 is moved out of engagement with an enclosure lip 48, the gas cylinder 18 is free to expand, thereby opening the lid 14 and allowing for easy access to the holster 38.

The design of the presently disclosed gun safe 10 allows it to be mounted in any physical orientation and still provide quick and easy access to the pistol 11 contained therein. For example, the gun safe 10 may be mounted overhead on the ceiling of a vehicle passenger compartment where it may be easily accessed, for example by a law enforcement officer. Immediately after the gun safe 10 is opened, the pistol 11 is still securely contained within the holster 38 by the protective material 40 engaged with the hook material. The protective material 40 is disengaged from the hook material so that the pistol 11 is ready to be extracted from the holster 38.

In another embodiment, the gun safe 10 may be mounted against the sidewall of a motor vehicle trunk interior. Alternatively, the gun safe 10 may be mounted into a motor vehicle armrest.

It will be appreciated from he present disclosure that the gas cylinder 18 will function to automatically open the gun sale 10 when the latching device 1.6 is activated no matter what orientation the gun safe 10 is mounted in, whether lid 14 up, lid 14 down, lid 14 sideways to the left, lid 14 sideways to the right, lid 14 vertical, etc.

While the disclosure has been illustrated and described in detail in the drawings in character, it being understood that only certain embodiments have been shown and described and that all changes and modifications that come within the spirit of the disclosure are desired to be protected. For example, the presently disclosed embodiments have been illustrated with the gun safe 10 being mounted in a motor vehicle; however, it will be appreciated by those skilled in the art that the gun safe 10 may be mounted in any location, such as the home, office, etc., and the present disclosure is intended to cover those alternatives.

What is claimed is:

1. A gun safe comprising:
a housing having an interior cavity;
a lid hingedly attached to the housing, the lid moveable between an open position and a closed position, wherein, in the closed position, the lid closes the interior cavity;
an electronic latch operable to retain the lid in the closed position and release the lid to the open position when the electronic latch is operated; and
a holster positioned on the interior surface of the lid, the holster configured to retain, a gun so that the gun is housed in the interior cavity when the lid is in the closed position.

2. The gun safe of claim 1 further comprising a gas cylinder coupling the lid and the housing, the gas cylinder moving the lid into the open position when the electronic latch is operated.

3. The gun safe of claim 1 further comprising a protective material lining the interior surface of the lid to protect the gun.

4. The gun safe of claim 3, wherein the protective material includes a cut out section to provide a gap between the interior surface of the lid and a handle of the gun.

5. The gun safe of claim 1, wherein the electronic latch is remotely operable.

6. The gun safe of claim 1 further comprising a linear actuator coupled to the latch to move the latch into the open position.

7. The gun safe of claim 6 further comprising a momentary switch electrically coupled to the linear actuator to activate the linear actuator.

8. The gun safe of claim 1 further comprising a key to override the electronic switch and manually release the lid to the open position.

9. A gun safe comprising:
a housing having an interior cavity;
a lid attached to the housing;
a gas cylinder coupling the lid to the housing, the lid moveable between an open position and a closed position, wherein, when the lid is moved to the closed position, gas within the gas cylinder is compressed;
a latch operable to retain the lid in the closed position, wherein, when the latch is operated, the gas in the gas cylinder expands to move the lid into the open position; and
a holster positioned on the interior surface of the lid, the holster configured to retain a gun so that the gun is housed in the interior cavity when the lid is in the closed position.

10. The gun safe of claim 9 further comprising a protective material lining the interior surface of the lid to protect the gun.

11. The gun safe of claim 10, wherein the protective material includes a cut out section to provide a gap between the interior surface of the lid and a handle of the gun.

12. The gun safe of claim 9, wherein the latch is an electronic latch.

13. The gun safe of claim 12, wherein the electronic latch is remotely operable.

14. The gun safe of claim 12 further comprising a linear actuator coupled to the latch to move the latch into the open position.

15. The gun safe of claim 14 further comprising a momentary switch electrically coupled to the linear actuator to activate the linear actuator.

16. The gun safe of claim 12 further comprising a key to override the electronic switch and manually release the lid to the open position.

17. A gun safe comprising:
a housing having an interior cavity;
a lid attached to the housing, the lid moveable between an open position and a closed position;
a gas cylinder coupling the lid to the housing and configured to move the lid into the open position;
an electronic latch operable to retain the lid in the closed position and release the lid to the open position when the electronic latch is operated;
a holster positioned on the interior surface of the lid, the holster configured to retain a gun so that the gun is housed in the interior cavity when the lid is in the closed position; and
a protective material lining the interior surface of the lid to protect the gun, the protective material having a cut out section to provide a gap between the interior surface of the lid and a handle of the gun.

18. The gun safe of claim 17 further comprising a linear actuator coupled to the latch to more the latch into the open position.

19. The gun safe of claim 18 further comprising a momentary switch electrically coupled to the linear actuator to activate the linear actuator.

20. The gun safe of claim 17 further comprising a key to override the electronic switch and manually release the lid to the open position.
